(19) United States
(12) Patent Application Publication
(10) Pub. No.: US 2023/0404320 A1
(43) Pub. Date: Dec. 21, 2023

(54) BEVERAGE MACHINE WITH NON-ISOLATED POWER SUPPLY FOR LIQUID CONTACTING COMPONENTS

(71) Applicant: Keurig Green Mountain, Inc., Burlington, MA (US)

(72) Inventors: David Nai-Zhi Cheung, Revere, MA (US); Shashank Shashikant Bakre, Burlington, MA (US)

(73) Assignee: Keurig Green Mountain, Inc., Burlington, MA (US)

(21) Appl. No.: 18/033,456

(22) PCT Filed: Oct. 26, 2021
(86) PCT No.: PCT/US2021/056652

§ 371 Date: Apr. 24, 2023

Related U.S. Application Data
(60) Provisional application No. 63/106,808, filed on Oct. 28, 2020.

(51) Int. Cl. A47J 31/44

(52) U.S. Cl. CPC A47J 31/4457

(57) ABSTRACT

Methods and systems for electrically powering liquid-contacting components of a beverage machine using a non-isolated power supply.

### CROSS REFERENCE TO RELATED APPLICATION

This application claims priority to U.S. Application No. 63/106,808, filed on Oct. 28, 2020, which is hereby incorporated by reference in its entirety.

### FIELD

This disclosure relates to beverage machines, such as coffee brewers that use a liquid to form a coffee beverage.

### BACKGROUND

Beverage machines typically include various electrically-powered components, such as pumps, sensors, valves, etc., and some such components may have portions that contact a liquid used to form a beverage that is dispensed. Often, electrically-powered components are powered by a relatively low voltage DC power supply, such as 12V DC, but the main power supply to the machine is usually at a significantly higher voltage, such as 120V AC. Beverage machines therefore frequently have a power converter of some type that converts incoming mains power from AC to DC and reduces the voltage.

### SUMMARY

For some beverage machine configurations, there may be a risk that a user will contact beverage liquid during machine operation, e.g., by putting a metal spoon into a cup of coffee while the coffee is dispensed from the beverage machine. Where the machine has components that contact the beverage liquid and are part of an electrically powered circuit, a user's contact with beverage liquid could expose the user to an electrical shock and so precautions to avoid such shocks may need to be taken. A common solution is to use an isolated power supply to power circuits having components that contact beverage liquid. An isolated power supply physically separates a main power supply (e.g., mains AC voltage supply) from a converted power output (e.g., 12V DC output), thereby preventing any liquid contacting components that use the converted power output from being connected to the main power supply. Such physical separation is typically provided by a transformer and allows for separate circuit neutral or ground connections for the input power and converted output power circuits. This can help ensure that components which are connected to the output power circuit are not exposed to voltages of the mains power supply. In contrast, non-isolated power supplies cannot physically separate input power and converted output power circuits due to the inherent features of their design, e.g., no transformer is used between the input and output power circuits. Thus, non-isolated power supplies must employ a common circuit neutral or ground for both input and output, and this can potentially expose a user to input power supply voltages and/or currents, e.g., in the case of component failure.

Given the inherent safety aspects of isolated power supplies, they are used with electrically powered components that contact beverage liquid or that otherwise might expose a user to electrical shocks. However, isolated power supplies have a lower efficiency and higher cost than non-isolated power supplies, and so are less desirable. The inventors have developed a circuit configuration that allows the safe use of a non-isolated power supply with beverage liquid-contacting components, such as sensors that contact the beverage liquid to detect its temperature and/or presence. As a result, a beverage machine can employ a non-isolated power supply for all machine components, and therefore can be made at lower cost and use less power for operation while providing safe operation for a user.

According to one aspect, a beverage machine is provided. The beverage machine may include a liquid supply configured to provide liquid for use in forming a beverage. The beverage machine may also include a sensor circuit including a sensor component arranged to contact liquid in the liquid supply. The sensor circuit may be arranged to detect a physical characteristic of the liquid. The beverage machine may also include a non-isolated power supply arranged to convert input electrical power to output electrical power having a lower voltage than the input electrical power. The beverage machine may also include a controller coupled to the sensor circuit and arranged to receive a signal from the sensor circuit indicative of the physical characteristic. The sensor circuit may be powered by the output electrical power of the non-isolated power supply and may be configured to limit a maximum possible current delivered by the sensor circuit to the liquid to be less than 2 milliamps.

These and other aspects of the disclosure will be apparent from the following description and claims. It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 is a perspective view of a beverage machine in an illustrative embodiment;

FIG. 2 is schematic diagram of selected components of the beverage machine in an illustrative embodiment; and

FIG. 3 is a diagram of a sensor circuit in an illustrative embodiment.

### DETAILED DESCRIPTION

It should be understood that aspects of the disclosure are described herein with reference to certain illustrative embodiments and the figures. The illustrative embodiments described herein are not necessarily intended to show all aspects of the disclosure, but rather are used to describe a few illustrative embodiments. Thus, aspects of the disclosure are not intended to be construed narrowly in view of the illustrative embodiments. In addition, it should be understood that aspects of the disclosure may be used alone or in any suitable combination with other aspects of the disclosure.

Generally speaking, a beverage machine may be used to form any suitable beverage, such as tea, coffee, other infusion-type beverages, beverages formed from a liquid or powdered concentrate, soups, juices or other beverages made from dried materials, carbonated or uncarbonated beverages. The beverage machine can form such beverages using a base liquid, such as water, stored in a liquid supply tank. A beverage machine can be capable of forming a variety of beverages, each requiring a different amount of the base liquid. Thus, it may be desirable for a beverage machine to include features that allow the beverage machine to measure a liquid level in the liquid supply tank and/or to detect liquid is being provided to the machine components. Such detection or performance of other machine components can require the use of electrically-powered components that have conductive portions which contact the liquid. Enabling the use of non-isolated power supplies for liquid contacting circuit components can provide benefits such as lower cost and better energy efficiency. Embodiments described herein allow the use of non-isolated power supplies with liquid-contacting components of a beverage machine.

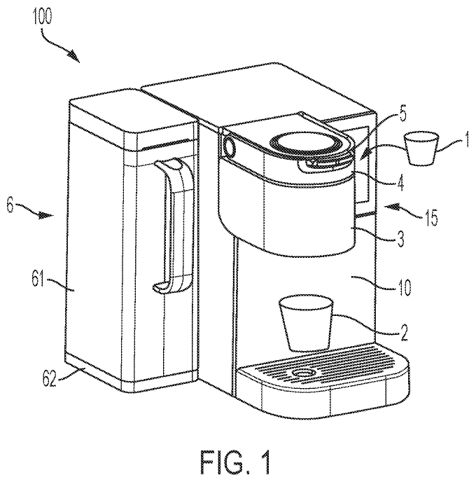

FIG. 1 shows a perspective view of a beverage machine 100 that incorporates features of this disclosure. In this illustrative embodiment, the machine 100 is arranged to form coffee or tea beverages. As is known in the art, a beverage cartridge 1 may be provided to the system 100 and used to form a beverage that is deposited into a user's cup or other suitable container 2. The cartridge 1 may be manually or automatically placed in a brew chamber of a beverage dispensing station 15 that in some embodiments includes a cartridge holder 3 and cover 4 of the beverage machine 100. For example, the holder 3 may be or include a circular, cup-shaped or otherwise suitably shaped opening in which the cartridge 1 may be placed. With a cartridge 1 placed in the cartridge holder 3, a handle 5 may be moved by hand (e.g., downwardly) so as to move the cover 4 to a closed position (as shown in FIG. 1). In the closed position, the cover 4 at least partially covers the cartridge 1, which is at least partially enclosed in a space in which the cartridge is used to make a beverage. For example, with the cartridge 1 held by the cartridge holder 3 in the closed position, water or other liquid may be provided to the cartridge 1 (e.g., by injecting the liquid into the cartridge interior) to form a beverage that exits the cartridge 1 and is provided to a cup 2 or other container. Of course, aspects of the disclosure may be employed with any suitably arranged system 100, including drip-type coffee brewers, carbonated beverage machines, and other systems that deliver water or other liquid to form a beverage. Thus, a cartridge 1 need not necessarily be used, but instead the beverage dispensing station 15 can accept loose coffee grounds or other beverage material to make a beverage. Also, the dispensing station 15 need not necessarily include a cartridge holder 3 and a cover 4. For example, dispensing station 15 can include a filter basket that is accessible to provide beverage material (such as loose coffee grounds), and the filter basket itself may be movable, e.g., by sliding engagement with the beverage machine 10 housing, and a cover 4 may be fixed in place. In other embodiments, the dispensing station 15 need not be user accessible, but instead beverage material may be automatically provided to, and removed from, the dispensing station 15. Moreover, the system 100 need not have a brew chamber, but instead other types of dispensing stations, e.g., that dispense hot and/or cold water (whether still or carbonated) at an outlet such as a dispensing nozzle without mixing with any beverage ingredient. Accordingly, a wide variety of different types and configurations for a dispensing station may be employed with aspects of this disclosure.

In some embodiments, the beverage machine 100 uses liquid, such as water, that is provided by a liquid supply 6 to form a beverage. In some embodiments, the liquid supply 6 can include a tank 61 arranged to hold water or other liquid. The tank 61 can be removably supported on a base 62, which fluidly couples to a port on a bottom of the tank 61 to receive and deliver liquid to other components of the machine 100, such as the dispensing station 15. A removable tank 61 can be convenient for a user because the user can remove the tank 61 from the base 62, e.g., by grasping a handle on the tank 61, for filling and then replace the tank 61 on the base 62. This is just one example, however, and a machine 100 can receive and/or store liquid in other ways. For example, the machine 100 can have a connection to a mains water supply (e.g., so-called “city water” or a line that delivers water under pressure to the machine 100), can have an internal or non-removable liquid supply tank or reservoir, or other.

In some embodiments, the machine 100 has electrically-powered components, and some of those components may contact liquid in the liquid supply 6. As an example, the machine 100 can include a sensor component that contacts liquid in the liquid supply 6 to detect a low water level in the tank 61, a temperature of water received from the tank 61 or other physical characteristics of the liquid. Such sensor components can be part of a sensor circuit that is electrically powered and used by a machine controller to detect the physical characteristic of the liquid. As an example, a controller can use a low water signal from a sensor circuit to provide an indication to a user that water needs to be added to the tank 61.

As described above, beverage machines use isolated power supplies to electrically power liquid-contacting components to reduce the risk of electric shock to a user that might contact the beverage liquid during dispensing or other operation. However, the inventor(s) have developed techniques to enable the use of non-isolated power supplies for liquid-contacting components, such as conductive probes used to detect the presence or absence of water by contacting the water in a liquid supply, while providing safe operating conditions for a user. In some embodiments, for example, the beverage machine 100 can have a sensor component arranged to detect a physical characteristic of the liquid in a supply line, such as the presence or absence of the liquid and/or a temperature of the liquid, and have an electrically conductive portion that is connectable to both a non-isolated power supply and the liquid.

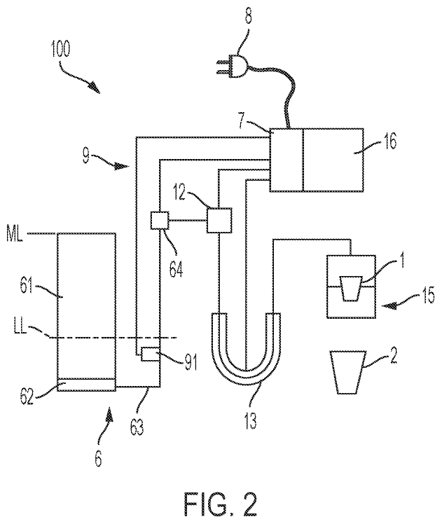

FIG. 2 shows a schematic diagram of selected beverage machine 100 components in one embodiment that employs a non-isolated power supply 7 to electrically power a sensor circuit 9 that has a sensor component 91 arranged to contact liquid in the liquid supply 6. In this example, the sensor component 91 includes a conductive probe that is arranged to contact liquid in a supply line 63 that is fluidly coupled to the tank 61 and arranged to deliver liquid to a pump 12. That is, the pump 12 has an inlet fluidly coupled to the supply line 63 to receive liquid from the tank 61, and an outlet fluidly coupled to provide liquid to a heater 13 (or other liquid conditioner such as a chiller, carbonator, etc.), which heats (cools, carbonates, etc.) the liquid that is subsequently delivered to the dispensing station 15. In some embodiments, the sensor component 91 can detect the presence or absence of liquid in the supply line 63, and thereby provide an indication that the tank 61 is disconnected from the machine 100, has an exhausted liquid supply and/or that a liquid level in the tank 61 is below a threshold level. In the arrangement of FIG. 2, the supply line 63 is fluidly coupled to the bottom of the tank 61 and extends upwardly, e.g., above a maximum liquid level ML of the tank 61. Since the sensor component 91 is arranged in the supply line 63, this can allow the sensor component 91 to detect whether liquid is present at least at one location in the line 63. In some embodiments, the pump 12 is also located at or above the maximum liquid level ML or at least above the location of the sensor component 91. This arrangement can allow a determination whether liquid is being supplied to the pump 12 or not and can be useful to determine whether the tank 61 is disconnected from the machine 100 and/or a liquid supply has been exhausted. In some cases, the sensor component 91 can detect whether a liquid level LL of liquid in the supply line 63 is above or below a location of the sensor component 91 along the supply line 63. This can allow a determination of whether a liquid level LL in the tank 61 is below a threshold level, such as a minimum level required to dispense a beverage. In some embodiments, the supply line 63 can include a vent 64 arranged to vent the supply line 63 to atmospheric or other ambient pressure, e.g., the vent 64 can include an electrically-operated valve that a controller 16 can open to expose the supply line 63 to ambient pressure. In some cases, the vent 64 can be positioned above the maximum liquid level ML and/or above a position of the sensor component 91. Venting of the supply line 63 can allow the liquid level in the supply line 63 to correspond to, or be the same as, the liquid level LL in the tank 61. Thus, if the supply line 63 is vented and the sensor component 91 detects the presence of liquid, the controller 16 can determine that the liquid level LL in the tank 61 is above the position or height of the sensor component 91 (e.g., above a threshold level), and if the sensor component 91 does not detect the presence of liquid (i.e., detects the absence of liquid), the controller 16 can determine that the liquid level LL in the tank 61 is below the position or height of the sensor component 91 or that the tank 61 is disconnected from the supply line 63. (In some embodiments, the beverage machine need not include a valve for the vent 64. For example, the vent 64 can have a permanently open orifice or other opening of suitable size to always vent the supply line 63 to atmosphere. The vent 64 opening sized can be arranged relative to the pump capacity such that the pump can deliver liquid for beverage formation even though air may be drawn into the vent 64.) In some embodiments, the controller 16 can provide an indication to the user to add liquid to the tank 61 and/or to replace the tank 61 if the sensor component 91 detects the absence of liquid. The sensor component 91 can also provide an indication that the tank 61 is removed while the pump 12 is drawing water from the tank 61. That is, if the tank 61 is removed as the pump 12 is pulling liquid from the supply line 63, liquid will no longer be provided to the inlet side of the supply line 63 and the pump 12 will empty the supply line 63. Once liquid is drawn upwardly past the sensor component 91, the sensor component 91 will no longer detect liquid, indicating that the tank 61 has been removed (or the tank 61 is exhausted of liquid).

The non-isolated power supply 7 receives input electrical power via a mains power connection 8 (such as a plug arranged to connect with a wall outlet or other power source) and conditions the input power to provide output power to the sensor circuit 9. The input electrical power may be arranged in various ways, but in general will be at a higher voltage than that used by the sensor circuit 9 and other components of the machine 100. As an example, the input electrical power can be about 120 Volts AC as provided within some residences. The non-isolated power supply 7 can be arranged to reduce the voltage of the input electrical power, e.g., to 12 Volts AC, and to convert the input electrical power to direct current, e.g., 12 Volt AC can be converted to 12 Volt DC. The non-isolated power supply 7 can use a plurality of impedances (e.g., resistors) to reduce the voltage of the input electrical power, and a voltage converter to convert the 12 Volt AC to 12 Volt DC. The non-isolated power supply 7 can also include a voltage regulator or other component to reduce the voltage of the converted DC power, e.g., to reduce the 12 Volt DC to 3.3 Volts DC. The 3.3 Volt DC output electrical power can be used to power the sensor circuit 9 as well as other components of the machine 100, such as parts of the controller 16. Similarly, the 12 Volt DC power can be used to power other components, such as the pump 12 and/or parts of the controller 16. In some cases, some components such as the heater 13 can be powered by unmodified input power, e.g., the input electrical power can be selectively directly connected to the heater 13 using relay switches or other components controlled by the controller 16. These are only illustrative embodiments, however, and the non-isolated power supply 7 can be arranged to produce other voltage levels using any suitable components. Regardless, the non-isolated power supply 7 employs a common ground or circuit neutral for input and output power. Note as well that the machine 100 can include other power supplies, such as isolated power supplies, to power other suitable components.

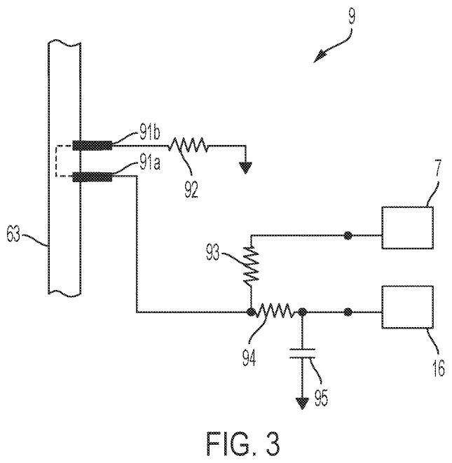

FIG. 3 shows an illustrative embodiment of a sensor circuit 9 including a sensor component 91 that can be employed in the FIG. 2 arrangement or others. In this example, the sensor component includes first and second conductive probes 91a, 91b that are arranged to contact the liquid in the liquid supply line 63. As an example, the conductive probes 91a, 91b can be molded into or otherwise arranged to have a portion that extends into the interior of a tube that is connected into the supply line 63. The conductive probes 91a, 91b are electrically insulated from each other except for a path through liquid present between the conductive probes 91a, 91b (represented by the dashed line in FIG. 3). Thus, if water or other liquid is present between the conductive probes 91a, 91b, a conductive path is established between the conductive probes 91a, 91b, but no conductive path is present if liquid is not present between the conductive probes 91a, 91b. This allows the sensor component 91 to detect the presence or absence of liquid. The first conductive probe 91a is connected to output electrical power of the non-isolated power supply 7, e.g., a 3.3 Volts DC power supply, via a power supply impedance 93. In some embodiments, the power supply impedance 93 has a resistance of about 1M Ohm, although other resistance values can be used and can be provided by one or more resistance elements. This power supply impedance 93 can prevent or limit current introduced into the liquid by the sensor circuit 9 to low levels, e.g., 2 milliamps or less, even in the case of some types of component failures. The second conductive probe 91b is connected to electrical ground or circuit neutral (represented by the downwardly pointed arrowhead) via a protective impedance 92. The protective impedance 92 helps prevent the sensor circuit 9 from introducing electrical current into the liquid that could expose a user to dangerous electrical shocks, e.g., if undesirable voltage/current is introduced into the circuit ground or neutral path connected to the second conductive probe 91b and the user contacts the beverage liquid during dispensing. In some embodiments, the sensor circuit including the protective impedance 92 can be configured to limit a maximum possible current delivered or deliverable by the sensor circuit to the liquid to be less than 2 milliamps or less, e.g., no more than 0.5 milliamps or 0.7 milliamps. Such a maximum possible current limit can be provided for both AC and DC, and for frequencies up to 1 kHz and voltages up to 450 Volts, e.g., in case there is a short circuit or other failure in the non-isolated power supply 7 or elsewhere. In some embodiments, the protective impedance 92 has a resistance of 1 k Ohms but other values may be used as suitable.

The controller 16 is coupled to the sensor circuit 9 via a connection to the first conductive probe 91a. As can be seen in FIG. 3, the controller 16 is coupled to the output side of the power supply impedance 93 via a sensor impedance 94. A capacitor 95 is also connected to the input side of the sensor impedance 94 and is connected to electrical ground or circuit neutral. In some embodiments, the sensor impedance 94 has a resistance of 1 k Ohms and the capacitor 95 has a capacitance of 100 nanofarads, although other resistance and/or capacitance values can be employed as suitable. Coupling of the controller 16 to the first conductive probe 91a in this way allows the controller 16 to detect a voltage at the first conductive probe 91a (or at least a value representative of such voltage), and thus the presence and absence of liquid at the sensor component 91. In other words, coupling of the controller 16 to the sensor circuit 9 allows the controller 16 to receive a signal from the sensor circuit 9 indicative of a physical characteristic of the liquid that is detected by the sensor component 91, e.g., the presence or absence of liquid. In some embodiments, a voltage at the first conductive probe 91a at a low level indicates the presence of liquid at the sensor component 91, e.g., because the liquid provides a conductive path between the probes 91a, 91b to circuit ground or neutral. A voltage at the first conductive prove 91a at a high level (which is higher than the low level), indicates the absence of liquid at the first and second conductive probes 91a, 91b. As an example, the high level voltage can be approximately 3.3 Volts DC (i.e., the voltage provided to the sensor circuit 9 by the non-isolated power supply 7), and the low level voltage can be 0.3 Volts or less.

While the sensor component 91 in the FIG. 3 embodiment includes at least one conductive element that contacts the liquid to detect the presence or absence of liquid, the sensor component 91 can be arranged in different ways and/or to detect other physical characteristics of the liquid. For example, the sensor component 91 can include a thermistor or other sensor arranged to contact liquid to detect a temperature of the liquid, a sensor arrangement to detect conductivity, salinity or other characteristic of the liquid, etc. In some embodiments, the sensor component 19 may detect two or more characteristics of the liquid, such as temperature and presence/absence. As an example, one of the first or second conductive probe 91a, 91b in FIG. 3 could be replaced with a thermistor sensor component that includes a conductive element arranged to contact liquid in the supply line 63 and so function as a conductive probe as well as temperature sensing. Thus, the sensor component 91 can operate as both a temperature sensor and a liquid presence/absence detector. (Additional sensor circuit 9 components would likely be required to allow for sensing temperature in addition to liquid presence/absence, e.g., a power supply line and signal line for the thermistor portion.) Moreover, inventive concepts regarding the use of non-isolated power supply for liquid-contacting components can be extended for use with other components that perform functions other than sensing. For example, a non-isolated power supply can be used to power components such as pumps, heaters, or others that have electrically-powered, liquid contacting portions.

To initiate a beverage cycle, a user may first insert a cartridge 1 into the dispensing station 15 and provide an indication (e.g., by pressing a button or other suitable step) to beverage machine 100 to prepare a beverage. At or before this time, the controller 16 can monitor the sensor circuit 9 to assess whether liquid is present at the sensor component 91 or not. If the supply line 63 is provided with a controllable vent 64, the controller 16 can open the vent valve 64 to help ensure that the liquid level in the supply line 63 is equal to the liquid level in the tank 61. If no liquid is detected, the controller 16 can stop beverage formation and provide an indication to the user, e.g., via a user interface on the housing 10, that water or other liquid must be added and/or the tank 61 replaced. If liquid is detected, the controller 16 can proceed with beverage formation, e.g., including closing the vent 64, operating the pump 12 to deliver liquid and/or operating the heater 13 to heat liquid delivered to the dispensing station 15. During pump 12 operation, the controller 16 can monitor the sensor circuit 9 for the absence of liquid. If an absence of liquid is detected, the controller 16 can stop pump operation, heating and/or other functions, e.g., because the tank 61 may have been removed and/or a liquid supply in the tank 61 exhausted. The controller 16 can provide an indication to a user via the user interface that the tank 61 should be replaced to begin or restart beverage dispensing.

As noted above, operation of the pump 12, heater 13 and other components of the machine 100 may be controlled by the controller 16, which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface on the housing 10), communication buses or other links, a display, switches, relays, triacs, or other components necessary to perform desired input/output or other functions. A user interface may be arranged in any suitable way and include any suitable components to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

While aspects of the disclosure may be used with any suitable cartridge, or no cartridge at all, some cartridges may include features that enhance the operation of a beverage machine 100. As is known in the art, the cartridge 1 may take any suitable form such as those commonly known as a sachet, pod, capsule, container or other. For example, the cartridge 1 may include an impermeable outer covering within which is housed a beverage medium, such as roasted and ground coffee or other. The cartridge 1 may also include a filter so that a beverage formed by interaction of the liquid with the beverage medium passes through the filter before being dispensed into a container 2. As will be understood by those of skill in the art, cartridges in the form of a pod having opposed layers of permeable filter paper encapsulating a beverage material may use the outer portion of the cartridge 1 to filter the beverage formed. The cartridge 1 in this example may be used in a beverage machine to form any suitable beverage such as tea, coffee, other infusion-type beverages, beverages formed from a liquid or powdered concentrate, etc. Thus, the cartridge 1 may contain any suitable beverage material, e.g., ground coffee, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutriaceuticals, etc.), and/or other beverage-making material (such as powdered milk or other creamers, sweeteners, thickeners, flavorings, and so on). In one illustrative embodiment, the cartridge 1 contains a beverage material that is configured for use with a machine that forms coffee and/or tea beverages, however, aspects of the disclosure are not limited in this respect.

Also, the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

As used herein, “beverage” refers to a liquid substance intended for drinking that is formed when a liquid interacts with a beverage material, or a liquid that is dispensed without interacting with a beverage material. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

1. A beverage machine comprising:
a liquid supply configured to provide liquid for use in forming a beverage;
a sensor circuit including a sensor component arranged to contact liquid in the liquid supply, the sensor circuit arranged to detect a physical characteristic of the liquid;
a non-isolated power supply arranged to convert input electrical power to output electrical power having a lower voltage than the input electrical power; and
a controller coupled to the sensor circuit and arranged to receive a signal from the sensor circuit indicative of the physical characteristic,
wherein the sensor circuit is powered by the output electrical power of the non-isolated power supply and is configured to limit a maximum possible current delivered by the sensor circuit to the liquid to be less than 2 milliamps.

2. The machine of claim 1, wherein the sensor component includes first and second conductive probes that are arranged to contact the liquid in the liquid supply and that are electrically insulated from each other except for a path through the liquid.

3. The machine of claim 2, wherein the first conductive probe is connected to the output electrical power, and the second conductive probe is connected to electrical ground via a protective impedance.

4. The machine of claim 3, wherein the protective impedance has a resistance of 1 k Ohms, and the output electrical power has a voltage of 3.3 Volts DC.

5. The machine of claim 3, wherein the physical characteristic is a presence or absence of liquid in the path between the first and second conductive probes, and the controller is arranged to detect the presence of the liquid at the first and second conductive probes when a voltage at the first conductive probe is at a low level, and to detect the absence of liquid at the first and second conductive probes when the voltage at the first conductive probe is at a high level that is higher than the low level.

6. The machine of claim 1, wherein the non-isolated power supply is arranged to receive input electrical power at 120 Volts AC and includes a plurality of impedances to reduce the voltage of the input electrical power to 12 Volts AC.

7. The machine of claim 6, wherein the non-isolated power supply includes a voltage converter to convert the 12 Volts AC power to 12 Volts DC power, and includes a voltage regulator to reduce the 12 Volts DC power to 3.3 Volts DC power which is used to power the sensor circuit.

8. The machine of claim 1, wherein the liquid supply includes a tank configured to hold the liquid for forming a beverage and a supply line arranged to supply liquid from the tank to a pump, wherein the sensor component is arranged to contact liquid in the supply line to detect a presence or absence of liquid.

9. The machine of claim 8, wherein the sensor component includes first and second conductive probes that are arranged to contact the liquid in the supply line and that are electrically insulated from each other except for a path through the liquid.

10. The machine of claim 9, wherein the tank and the supply line are arranged such that a liquid level in the supply line corresponds to a liquid level in the tank, and wherein the sensor component is positioned in the supply line at a location that corresponds to a liquid level below which the controller provides an indication to a user to add liquid to the tank.

11. The machine of claim 10, wherein the supply line includes a vent to vent the supply line to atmosphere such that the liquid level in the supply line corresponds to the liquid level in the tank.

12. The machine of claim 10, wherein the liquid supply includes a pump having an inlet fluidly coupled to the supply line to receive liquid from the tank, and wherein the pump is positioned above the sensor component.

13. The machine of claim 8, the liquid supply includes the pump, a heater and a beverage dispensing station, the pump having an inlet fluidly coupled to the supply line to receive liquid from the tank and an outlet fluidly coupled to provide the liquid to the heater, the heater being fluidly coupled to the beverage dispensing station to deliver heated liquid to the beverage dispensing station.

14. The machine of claim 13, wherein the non-isolated power supply is arranged to provide power to the pump and the controller.

15. The machine of claim 8, wherein the supply line is fluidly coupled to a bottom of the tank to receive liquid from the tank and extends upwardly above a maximum liquid level of the tank.

16. The machine of claim 1, wherein the sensor component includes an electrically conductive portion that is connectable to the output electrical power and that is arranged to contact the liquid.

17. The machine of claim 16, wherein the sensor component is arranged to detect a temperature of the liquid.

18. The machine of claim 17, wherein the sensor component is arranged to detect a presence and an absence of the liquid at the sensor component.

19. The machine of claim 18, wherein the sensor component includes a first conductive probe arranged to contact the liquid in the liquid supply and a thermistor device arranged to detect a temperature of the liquid, the thermistor device including the electrically conductive portion which is electrically insulated from the first conductive probe except for a path through the liquid.
